(19) United States
(12) Patent Application Publication
(10) Pub. No.: US 2023/0186178 A1
(43) Pub. Date: Jun. 15, 2023

(54) GROUP EVENT SCHEDULING AND URGENCY PROMOTING SYSTEM AND METHOD

(71) Applicant: Hoozin Technology, Inc., Los Angeles, CA (US)

(72) Inventor: Josh Caleb Kline, Los Angeles, CA (US)

(21) Appl. No.: 18/065,537

(22) Filed: Dec. 13, 2022

Related U.S. Application Data
(60) Provisional application No. 63/289,011, filed on Dec. 13, 2021.

(51) Int. Cl. G06Q 10/02; G06Q 30/0201

(52) U.S. Cl. CPC G06Q 10/02; G06Q 30/0206

(57) ABSTRACT

A group event scheduling and urgency promotion system and software-implemented method are disclosed that tap into a person's fear of missing out by notifying them of the diminishing number of available guest spots to the events to which they have been invited. The method includes: generating an event campaign for an event that has a limited number of acceptable invitations, send event invitations for the event campaign with an limited number of acceptable invitations to a plurality of available guests, wherein the event invitations specifically states the limited number of acceptable invitations, receiving acceptance of an event invitation for the event campaign with an limited number of acceptable invitations from one of the plurality of available guests, and sending updated event invitations for the event campaign with an updated and decremented limited number of acceptable invitations to a remaining plurality of available guests.

### TECHNICAL FIELD

The present disclosure pertains to a group event scheduling system and method, and particularity, a group event scheduling and urgency promoting system and method.

### BACKGROUND

### Description of the Related Art

Current group event scheduling software is inefficient because event invitees do not have a sense of urgency to respond quickly. This creates additional work for the event hosts who must communicate via other platforms such as email, text and messaging apps in order to finalize event attendees.

Other group event invitation options merely distribute invitations (either physically or digitally) to event invitees and tally their responses. Therefore, what is needed is a way to motivate event invitees to declare, in a faster time frame, an intention of participation or attendance at the event or not.

Furthermore, there is a continuing desire to improve methods of group event invitation and scheduling systems. The present disclosure addresses this and other needs.

### BRIEF SUMMARY

The present disclosure is directed towards a novel group event scheduling and urgency promoting system and software-implemented process. In some embodiments, the group event scheduling and urgency promoting system is configured to trigger a fear response by leveraging supply-driven resource scarcity. This creates a sense of urgency on the part of event invitees to respond to event invitations before all available guest spots have been claimed. In some embodiments, the group event scheduling and urgency promoting system triggers the fear response by manifesting resource scarcity through communicating with invited guest to notify them of the diminishing number of available guest spots to the event to which they have been invited. The fear response is specifically designed to tap into a naturally occurring fear of missing out (“FOMO”) which people experience when the available supply of resources is understood to be diminishing.

Briefly stated, embodiments of the present disclosure are directed towards a system for group event scheduling and urgency promotion. The system includes a remote server with a server memory that stores server computer instructions and a server processor.

Executing the server computer instructions causes the remote server to: generate an event campaign for an event that has a limited number of acceptable invitations; send event invitations for the event campaign with an limited number of acceptable invitations to a plurality of available guests, wherein the event invitations specifically states the limited number of acceptable invitations; receive an acceptance of an event invitation for the event campaign with an limited number of acceptable invitations from one of the plurality of available guests; send updated event invitations for the event campaign with an updated and decremented limited number of acceptable invitations to a remaining plurality of available guests, in response to the acceptance of an event invitation for the event campaign with an limited number of acceptable invitations; receive additional acceptances of one or more updated event invitations for the event campaign with a limited number of acceptable invitations from one or more of the plurality of available guests; send further updated event invitations for the event campaign with further updated and decremented limited numbers of acceptable invitations to the remaining plurality of available guests, in response to the additional acceptances of one or more event invitations for the event campaign with an limited number of acceptable invitations; receive a final acceptance of a last event invitation for the event campaign with a limited number of acceptable invitations from a final guest of the remaining plurality of available guests; and send a final notification for the event campaign to the remaining plurality of available guests which states that the event is now fully booked, in response to the final acceptance of a last event invitation for the event campaign with a limited number of acceptable invitations.

In some embodiments of the system for system for group event scheduling and urgency promotion, the system further includes a plurality of mobile computing devices, each personal mobile computing device including a device memory that stores device computer application instructions and a device processor. Executing the device computer application instructions (e.g., an App) causes the personal mobile computing device to: receive, at a mobile computing device of the plurality of mobile computing devices, event invitations for the event campaign with a limited number of acceptable invitations, wherein the event invitations specifically states the limited number of acceptable invitations; send, at the mobile computing device of the plurality of mobile computing devices, an acceptance of an event invitation for the event campaign with an limited number of acceptable invitations; receive, at another mobile computing device of the plurality of mobile computing devices, an updated event invitation for the event campaign with an updated and decremented limited number of acceptable invitations; send, at the another mobile computing device of the plurality of mobile computing devices, an additional acceptance of an event invitation for the event campaign with a limited number of acceptable invitations; and receive, at still another mobile computing device of the plurality of mobile computing devices, a final notification for the event campaign to the remaining plurality of available guests which states that the event is now fully booked.

In another aspect of some embodiments, the event invitation for the event campaign with an limited number of acceptable invitations includes purchase information regarding the acceptable invitations, wherein the purchase information includes a price. In still another aspect of some embodiments, the event invitation for the event campaign with an limited number of acceptable invitations includes a purchase link to the acceptable invitations for immediate purchasing of an acceptable invitation. In yet another aspect of some embodiments, the event invitations, updated event invitations, and final notifications are included in one or more of text messages, emails, instant messages, social media messages, or notifications.

In one or more embodiments, the updated event invitation for the event campaign with an updated and decremented limited number of acceptable invitations includes updated purchase information regarding the acceptable invitations after one or more purchases of acceptable invitations have occurred, wherein the updated purchase information includes a price change. In another aspect of some embodiments, the updated event invitation for the event campaign with an updated and decremented limited number of acceptable invitations includes purchase link to the updated and decremented limited number of acceptable invitations. In still another aspect of some embodiments, the price change is a price increase or a price decrease.

Other embodiments of the present disclosure are directed towards a method for group event scheduling and urgency promotion. The method includes: generating an event campaign for an event that has a limited number of acceptable invitations; sending event invitations for the event campaign with an limited number of acceptable invitations to a plurality of available guests, wherein the event invitations specifically states the limited number of acceptable invitations; receiving an acceptance of an event invitation for the event campaign with an limited number of acceptable invitations from one of the plurality of available guests; sending updated event invitations for the event campaign with an updated and decremented limited number of acceptable invitations to a remaining plurality of available guests; receiving additional acceptances of one or more updated event invitations for the event campaign with a limited number of acceptable invitations from one or more of the plurality of available guests; sending updated event invitations for the event campaign with updated and decremented limited numbers of acceptable invitations to the remaining plurality of available guests; receiving a final acceptance of a last event invitation for the event campaign with a limited number of acceptable invitations from a final guest of the remaining plurality of available guests; and sending a final notification for the event campaign to the remaining plurality of available guests which states that the event is now fully booked.

In some embodiments of the method for group event scheduling and urgency promotion, the method further includes: receiving, at a mobile computing device of the plurality of mobile computing devices, event invitations for the event campaign with a limited number of acceptable invitations, wherein the event invitations specifically states the limited number of acceptable invitations; sending, at the mobile computing device of the plurality of mobile computing devices, an acceptance of an event invitation for the event campaign with an limited number of acceptable invitations; receiving, at another mobile computing device of the plurality of mobile computing devices, an updated event invitation for the event campaign with an updated and decremented limited number of acceptable invitations; sending, from the another mobile computing device of the plurality of mobile computing devices, an additional acceptance of an event invitation for the event campaign with a limited number of acceptable invitations; and receiving, from still another mobile computing device of the plurality of mobile computing devices, a final notification for the event campaign to the remaining plurality of available guests which states that the event is now fully booked.

In another aspect of some embodiments of the method, the event invitation for the event campaign with an limited number of acceptable invitations includes purchase information regarding the acceptable invitations, wherein the purchase information includes a price. In still another aspect of some embodiments, the event invitation for the event campaign with an limited number of acceptable invitations includes a purchase link to the acceptable invitations for immediate purchasing of an acceptable invitation. In yet another aspect of some embodiments, the event invitations, updated event invitations, and final notifications are included in one or more of text messages, emails, instant messages, social media messages, or notifications.

In one or more embodiments of the method, the updated event invitation for the event campaign with an updated and decremented limited number of acceptable invitations includes updated purchase information regarding the acceptable invitations after one or more purchases of acceptable invitations have occurred, wherein the updated purchase information includes a price change. In another aspect of some embodiments, the updated event invitation for the event campaign with an updated and decremented limited number of acceptable invitations includes purchase link to the updated and decremented limited number of acceptable invitations. In still another aspect of some embodiments, the price change is a price increase or a price decrease.

Still other embodiments of the present disclosure are directed towards a system for group event scheduling and urgency promotion. The system includes a remote server with a server memory that stores server computer instructions and a server processor. Executing the server computer instructions causes the remote server to: generate an event campaign for an event that has a limited number of acceptable invitations; send event invitations for the event campaign with an limited number of acceptable invitations to a plurality of available guests, wherein the event invitations specifically states the limited number of acceptable invitations; receive an acceptance of an event invitation for the event campaign with an limited number of acceptable invitations from one of the plurality of available guests; and send updated event invitations for the event campaign with an updated and decremented limited number of acceptable invitations to a remaining plurality of available guests, in response to the acceptance of an event invitation for the event campaign with an limited number of acceptable invitations.

In another aspect of some embodiments, the system enables an alert to be sent to an alert-requesting available guest when a selected number of acceptable invitations are remaining that notifies the available guest of the selected number of acceptable invitations that are remaining. In still another aspect of some embodiments, the system enables an automatic purchase to be executed for a requesting available guest when a selected number of acceptable invitations are remaining. In yet another aspect of some embodiments, the event invitation for the event campaign with an limited number of acceptable invitations includes a purchase link to the acceptable invitations for immediate purchasing of an acceptable invitation.

Still other embodiments of the present disclosure are directed towards a non-transitory computer-readable storage medium having computer-executable instructions stored thereon.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of an environment that provides a system for group event scheduling and urgency promotion in accordance with embodiments described herein;

FIG. 2A illustrates a “sign up, information request” screen shot of a downloadable application for the group event scheduling and urgency promotion system, in accordance with embodiments described herein;

FIG. 2B illustrates a “sign up, email confirmation” screen shot of a downloadable application for the group event scheduling and urgency promotion system, in accordance with embodiments described herein;

FIG. 3A illustrates a “login page” screen shot of a downloadable application for the group event scheduling and urgency promotion system, in accordance with embodiments described herein;

FIG. 3B illustrates a “lost password” page screen shot of a downloadable application for the group event scheduling and urgency promotion system, in accordance with embodiments described herein;

FIG. 3C illustrates a “login address book” page screen shot of a downloadable application for the group event scheduling and urgency promotion system, in accordance with embodiments described herein;

FIG. 4A illustrates an “events list” page screen shot of a downloadable application for the group event scheduling and urgency promotion system, in accordance with embodiments described herein;

FIG. 4B illustrates a “new event” page screen shot of a downloadable application for the group event scheduling and urgency promotion system, in accordance with embodiments described herein;

FIG. 4C illustrates an “events details” page screen shot of a downloadable application for the group event scheduling and urgency promotion system, in accordance with embodiments described herein;

FIG. 5A illustrates an “add invitees” page screen shot of a downloadable application for the group event scheduling and urgency promotion system, in accordance with embodiments described herein;

FIG. 5B illustrates an “invitees search” page screen shot of a downloadable application for the group event scheduling and urgency promotion system, in accordance with embodiments described herein;

FIG. 5C illustrates an “event invitees” page screen shot of a downloadable application for the group event scheduling and urgency promotion system, in accordance with embodiments described herein;

FIG. 6A illustrates a “my events list” page screen shot of a downloadable application for the group event scheduling and urgency promotion system, in accordance with embodiments described herein;

FIG. 6B illustrates an “others events list” page screen shot of a downloadable application for the group event scheduling and urgency promotion system, in accordance with embodiments described herein;

FIG. 6C illustrates an “others events details” page screen shot of a downloadable application for the group event scheduling and urgency promotion system, in accordance with embodiments described herein;

FIG. 6D illustrates an “others events invitees” page screen shot of a downloadable application for the group event scheduling and urgency promotion system, in accordance with embodiments described herein;

FIG. 6E illustrates an “others event details accept” page screen shot of a downloadable application for the group event scheduling and urgency promotion system, in accordance with embodiments described herein;

FIG. 7 illustrates an “events status” page screen shot of a downloadable application for the group event scheduling and urgency promotion system, in accordance with embodiments described herein;

FIG. 8A illustrates a “contacts” page screen shot of a downloadable application for the group event scheduling and urgency promotion system, in accordance with embodiments described herein;

FIG. 8B illustrates an empty “new contact” page screen shot of a downloadable application for the group event scheduling and urgency promotion system, in accordance with embodiments described herein;

FIG. 8C illustrates a completed “new contact” page screen shot of a downloadable application for the group event scheduling and urgency promotion system, in accordance with embodiments described herein;

FIG. 8D illustrates a “contact details” page screen shot of a downloadable application for the group event scheduling and urgency promotion system, in accordance with embodiments described herein;

FIG. 8E illustrates a “contacts—new group” page screen shot of a downloadable application for the group event scheduling and urgency promotion system, in accordance with embodiments described herein;

FIG. 9A illustrates a “contacts—add members” page screen shot of a downloadable application for the group event scheduling and urgency promotion system, in accordance with embodiments described herein;

FIG. 9B illustrates a “contacts—create new group” page screen shot of a downloadable application for the group event scheduling and urgency promotion system, in accordance with embodiments described herein;

FIG. 9C illustrates a “contacts—group details” page screen shot of a downloadable application for the group event scheduling and urgency promotion system, in accordance with embodiments described herein;

FIG. 9D illustrates a “contacts—group details edit” page screen shot of a downloadable application for the group event scheduling and urgency promotion system, in accordance with embodiments described herein;

FIG. 10 illustrates a “contacts—invite link” page screen shot of a downloadable application for the group event scheduling and urgency promotion system, in accordance with embodiments described herein;

FIG. 11A illustrates a “settings—profile details” page screen shot of a downloadable application for the group event scheduling and urgency promotion system, in accordance with embodiments described herein;

FIG. 11B illustrates a “settings—edit profile” page screen shot of a downloadable application for the group event scheduling and urgency promotion system, in accordance with embodiments described herein;

FIG. 12 illustrates is a logic diagram showing the operations in a method for group event scheduling and urgency promotion; and

FIG. 13 illustrates a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

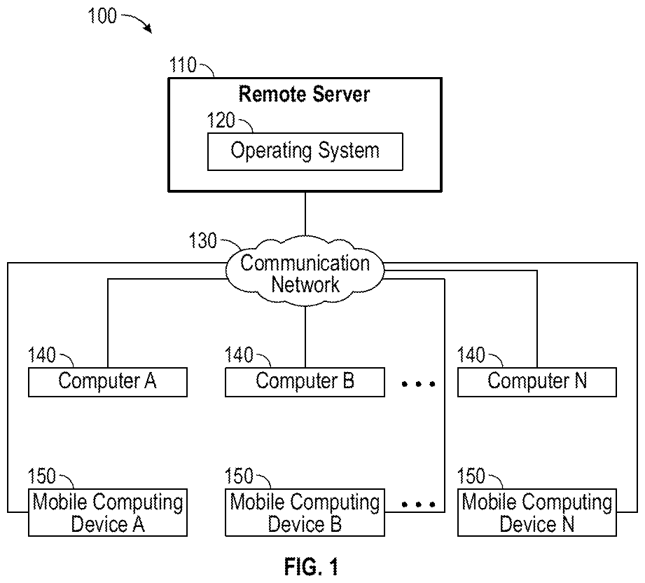

FIG. 1 illustrates a context diagram that presents one implementation of a computing system for group event scheduling and urgency promoting system. The group event scheduling and urgency promoting system 100 includes server 110 and an operating system 120 that are connected, via a communication network 130, to one or more computers 140 (computer A, computer B, . . . computer N) and one or more mobile computing devices 150 (mobile computing device A, mobile computing device B, . . . mobile computing device N).

Some disclosed embodiments include a group event scheduling and urgency promoting system and software-implemented method. In some embodiments, the group event scheduling and urgency promoting system is configured to trigger a fear response by leveraging supply-driven resource scarcity. This creates a sense of urgency on the part of event invitees to respond to event invitations before all available guest spots have been claimed. In some embodiments, the group event scheduling and urgency promoting system triggers the fear response by manifesting resource scarcity through communicating with invited guest to notify them of the diminishing number of available guest spots to the event to which they have been invited. The fear response is specifically designed to tap into a naturally occurring fear of missing out (“FOMO”) which people experience when the available supply of resources is understood to be diminishing.

As stated above, current group event scheduling software is inefficient because event invitees do not have a sense of urgency to respond quickly. This creates additional work for the event hosts who must communicate via other platforms such as email, text and messaging apps in order to finalize event attendees. Other group event invitation options merely distribute invitations (either physically or digitally) to event invitees and tally their responses.

Embodiments of the group event scheduling and urgency promoting system and software-implemented method described in this specification solve such problems by leveraging the economic concept of supply-driven resource scarcity. Resource scarcity, when made evident by the group event scheduling and urgency promoting system and software-implemented method, creates a sense of urgency on the part of the event invitees by tapping into their FOMO, thereby alleviating additional work on the part of the event hosts. The group event scheduling and urgency promoting system and software-implemented method does this by notifying the event attendees of the diminishing number of available guest spots as other event invitees accept invites. Also, when the last available guest spot is taken for any given event, all of that event invitees are notified that the event is full and no more invitees may accept their invitation, thereby reducing over-capacity problems that occur when multiple invitees over a limit respond, and also maintaining a sense of urgency to respond quickly the next time any event invitee is notified of an event via the software.

Embodiments of the group event scheduling and urgency promoting system and software-implemented method described in this specification differ from and improve upon currently existing options. In particular, no other group event scheduling software leverages supply-driven resource scarcity in order to create a sense of urgency on the part of event invitees to respond to event invitations before all available guest spots have been claimed. In addition, other group event invitation options (either physical or via digital platforms) lack a mechanism to motivate a change in behavior that will result in event invitees responding with urgency. A limited number of available guest spots for any event equates to a scarce resource (i.e., limited quantity) and the group event scheduling and urgency promoting system and software-implemented method uses the FOMO in order to motivate invitees to respond to event invitations expeditiously.

The group event scheduling and urgency promoting system and software-implemented method of the present disclosure may be comprised of the following elements (a server or personal computer with text input access and capable of running a web browser, or smartphone; a network connection to a communication network; an event with a limited number of available invitee spots; a list of invitees to invite to the event; and non-transitory computer-readable storage medium having computer-executable instructions stored thereon). This list of possible constituent elements is intended to be exemplary only and it is not intended that this list be used to limit the group event scheduling and urgency promoting system and software-implemented method of the present application to just these elements. Persons having ordinary skill in the art relevant to the present disclosure may understand there to be equivalent elements that may be substituted within the present disclosure without changing the essential function or operation of the group event scheduling and urgency promoting system and software-implemented method.

The various elements of the group event scheduling and urgency promoting system and software-implemented method of the present disclosure may be related in the following exemplary fashion. The personal computer with text input access and capable of running a web browser, or smartphone activates the client-side software (downloadable application, i.e., “App”). Using the software App the event creator user enters the scheduled event detail metadata including event name, date and number of attendees. The event creator either selects a pre-configured list of invitees or creates a new list of invitees and directs the App to distribute the invitations. The App transmits the event information and invitee information via internet or cellular network connection to the server-side software, which then registers the transmitted data and distributes the event invitation information to the invitees. As individual invitees accept invitations to the event the list of invitees is notified of the diminishing number of available guest spots. When the last available guest spot is taken by an invitee, the list of invitees is notified that there are no more guest spots available to the event.

The group event scheduling and urgency promoting system and software-implemented method of the present disclosure generally works by software which manages the descriptive information about events to which groups of people may be invited. The event and guest data is entered in the client-side software, managed via the server-side software which is connected to the client-side software by internet or cellular network connection, and the invitees receive notifications on their devices via their installed copies of the client-side software of other messaging options (e.g. email, SMS). The method of notifying event invitees of a diminishing number of remaining guest spots for specific events is what triggers the invitees to respond more expeditiously due to the concept of supply-driven resource scarcity, wherein the invitees are reminded via the software installed on their computer or smartphone devices that there is an event to which they have been invited, a diminishing number of guest spots for said event, and if they do not respond to the invitation expeditiously they may lose out on the opportunity to attend said event.

Once the event creator user has installed the software on their computer or smartphone, the event creator user must create an event to which they will invite a number of potential guests. Once the event creator user enters the data describing the event into the software (e.g. title, date, time, location, number of guests that may attend), the event creator user must then either select a preexisting list of invitees within the software, or create a new list of invitees by entering their contact info (e.g. name, mobile phone number) into the software. Once the list of invitees is selected or created, the event creator user then initiates the event invitation notification method. Then, invitees who already have the software installed on their computers or smartphones will receive notifications via that software on their devices. Invitees that do not yet have the software installed on their computers or smartphones will receive a notification that they have been invited to an event via external internet or cellular network messaging options (e.g. email, SMS), with a link to download the software so that they may respond. As invitees respond to the event invitation, the remaining event invitees are notified of the dwindling number of available guest spots until such time as there are no more available guest spots, and all invitees are notified that the event is now fully booked.

To make the group event scheduling and urgency promoting system and software-implemented method of the present disclosure, a person may design, code, and implement software that is able to carry out the functions of event invitation systems and incorporate modules and methods for tapping into the fear of missing out of the invitees. This can be accomplished through communication, such as notifying invitees of the limited remaining time (via timer or countdown) and the limited and diminishing event spots from which they can choose. Integration with third-party contact management software would allow for enhanced ease in creating event invitee lists. Integration with third-party calendar software would allow for enhanced ease in scheduling around invitee free/busy calendar information. Integration with third-party messaging software would allow for enhanced ease in notifying invitees of event invitations and updates. The addition of a time countdown-based invitation method to the group event scheduling and urgency promoting system and software-implemented method would allow for an additional invitation type that also leverages supply-driven resource scarcity in order to drive expeditious responses from event invitees. In some embodiments, the group event scheduling and urgency promoting system is deployed in a networked environment. In some embodiments, the networked environment comprises a person-to-person network that is configured to connect users of the client-side software directly to one another (also, “peer-to-peer” or “P2P” network). In such scenario, the software on each user's computer or smartphone device would be directly connected for communication with the other users' software, without requiring the event and invitee data to be managed via server-side software. Also, if a timed countdown invitation method, such as that noted above, were included or added, the group event scheduling and urgency promoting system and software-implemented method would still be able to be based on a person-to-person or P2P network architecture. Notably, this type of networked software architecture is common among software running on blockchains.

To use the group event scheduling and urgency promoting system and software-implemented method of the present disclosure, the event creator user creates an event via the software on their computer or smartphone device. The event data includes title, location, time, date, and a number of invitees that may take a guest spot. The event creator user selects a pre-existing invitee list via the software, or creates a new one, and determines whether the invitee names will be visible to each another or not. Then the event creator user saves the data via the software and the invitations are distributed to the invitees. Invitees who already have the software installed on their devices will receive an in-app notification and may receive a notification via other messaging services such as email or SMS with instructions on how to download the software so that they may review and respond to the event invitation As invitees claim available guest spots to the event via the software, the remaining invitees are notified of the decreasing number of available guest spots until the last one is claimed, at which time all invitees are notified that the guest list is now closed, and all available guest spots have been claimed. All users may review open event invitations to which they have been invited.

Additionally, the group event scheduling and urgency promoting system and software-implemented method can be adapted for use to allocate any type of limited resource among a defined pool of possible invitees in order to create the motivation for expeditious responses among possible consumers of said resource. For instance, the group event scheduling and urgency promoting system and software-implemented method can be deployed by concert and event promoters who could avail tickets to groups of potential attendees. Similarly, the group event scheduling and urgency promoting system and software-implemented method could be utilized by retailers who could distribute discount codes among potential customers or restaurants which could allocate reservations among potential diners. Furthermore, footwear and apparel manufacturers could employ the group event scheduling and urgency promoting system and software-implemented method to avail limited release products to interested customers. Likewise, sports clubs could allocate team spots to interested participants, blockchain users who mint non-fungible tokens (NFTs) could allocate them among interested collectors, real estate developers could sell limited partnership ownership or partial ownership in their projects, and/or technology investors could sell limited partnership ownership or partial ownership in their funds.

As described above with respect to FIG. 1, the group event scheduling and urgency promoting system 100 includes server 110 and an operating system 120 that executes the server-side portion of the software enabled computer instructions. Additionally, end users of the group event scheduling and urgency promoting system 100 download the client-side portion of the software enabled computer instructions, which are commonly referred to as computer applications or “Apps”. The Apps are downloaded over a communication network 130, to one or more computers 140 (e.g., desktop computers, laptop computers, etc.) and/or one or more mobile computing devices 150 (e.g., smart phones, tablets, smart watches, etc.).

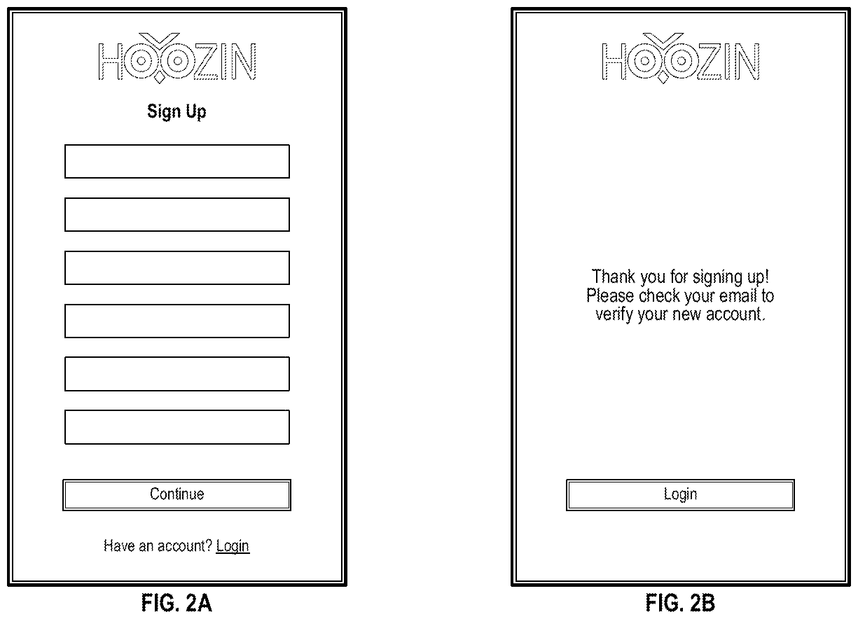

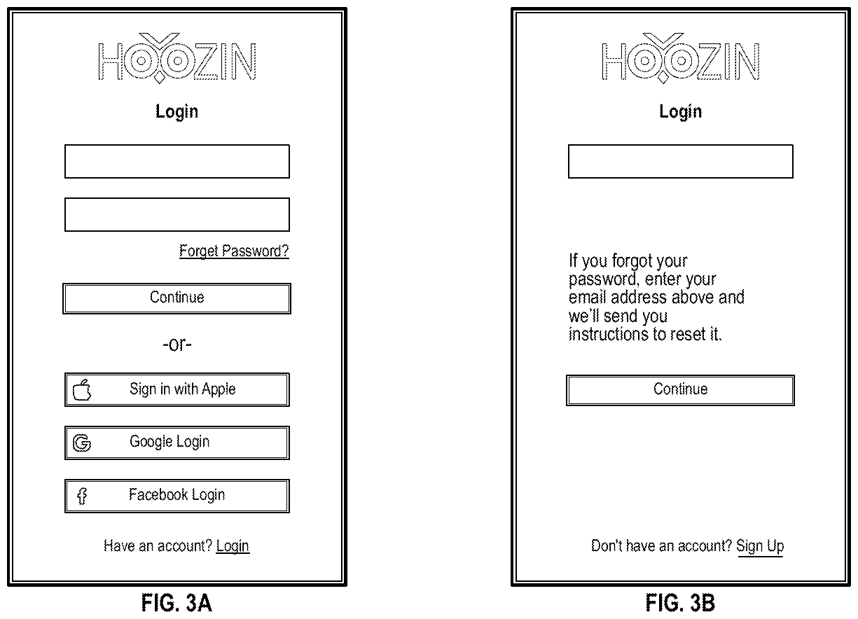

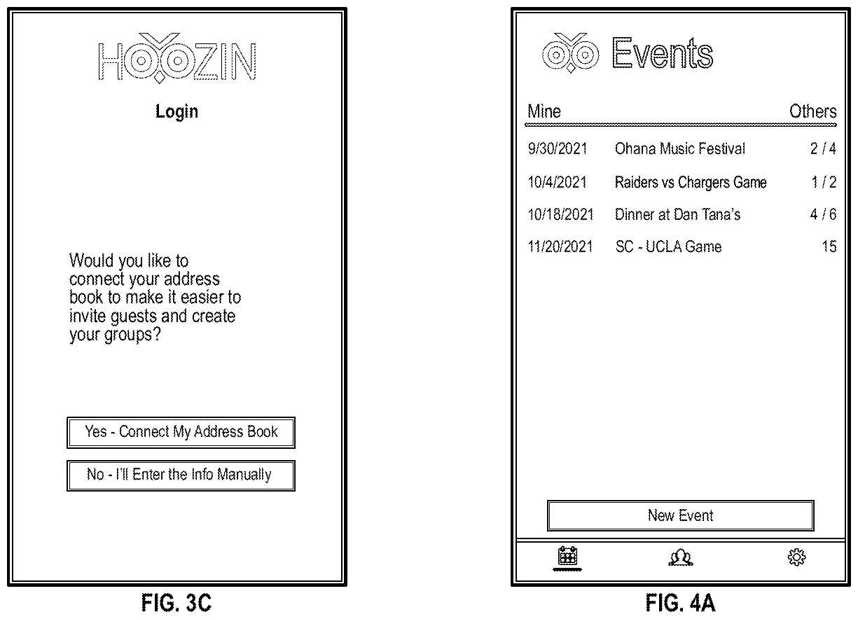

Referring now to FIG. 2A, a “sign up, information request” screen shot is shown of a downloadable application for the group event scheduling and urgency promotion system 100 where a user enters their personal information. FIG. 2B shows a “sign up, email confirmation” screen shot of the App for the group event scheduling and urgency promotion system 100 where the end user is prompted to check their email to verify their new account. FIG. 3A shows a “login page” screen shot of the App for the group event scheduling and urgency promotion system 100 where the user enters his or her username and password. FIG. 3B shows a “lost password” page screen shot of the App for the group event scheduling and urgency promotion system 100 that is displayed if the end user has forgotten their password. FIG. 3C shows a “login address book” page screen shot of the App for the group event scheduling and urgency promotion system 100 where the end user is prompted to connect the address book of their smartphone to the address book of the system 100.

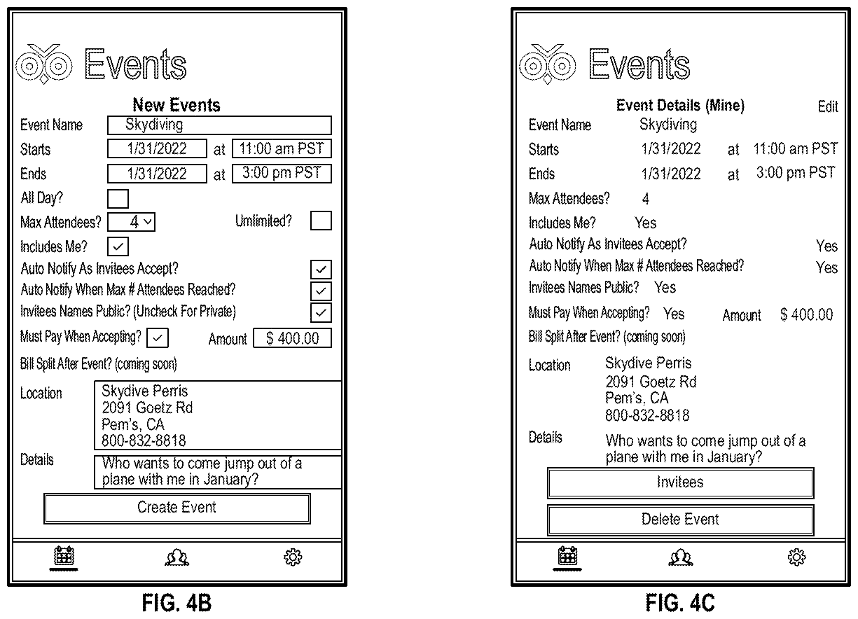

Referring now to FIG. 4A, an “events list” page screen shot is shown of the App for the group event scheduling and urgency promotion system 100 that displays events, events dates, and available tickets remaining for the listed events. FIG. 4B shows a “new event” page screen shot of the App for the group event scheduling and urgency promotion system 100 where new event details are entered for the creation of a new event. FIG. 4C shows an “events details” page screen shot of the App for the group event scheduling and urgency promotion system 100 where new event details are confirmed for the new event.

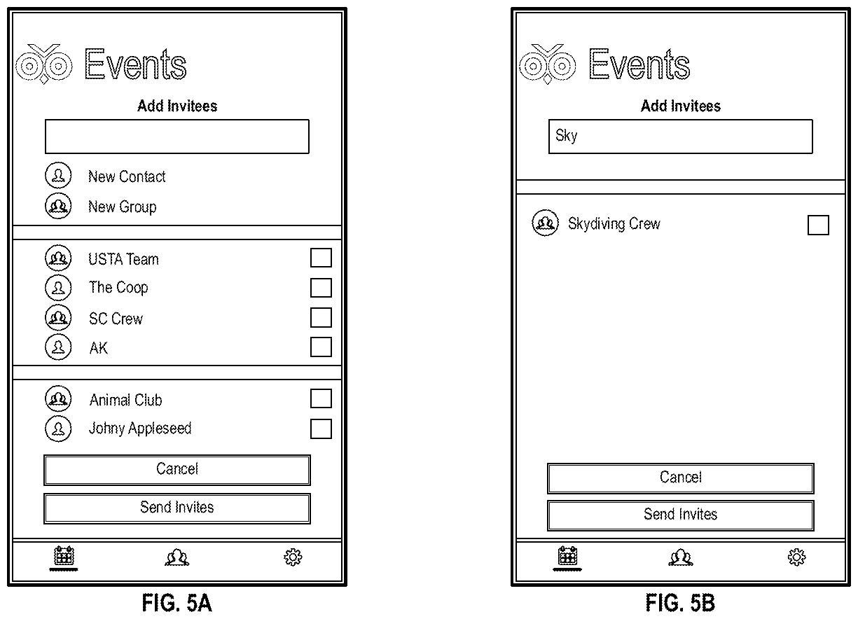

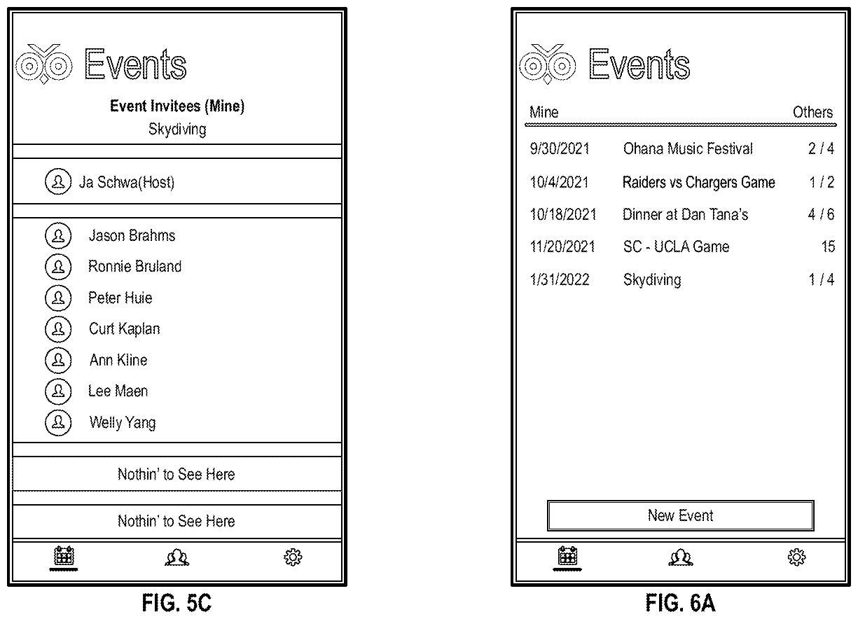

FIG. 5A shows an “add invitees” page screen shot of the App for the group event scheduling and urgency promotion system 100, where new invitees are added. FIG. 5B shows an “invitees search” page screen shot of the App for the group event scheduling and urgency promotion system 100 where invitee search functions are enabled. FIG. 5C shows an “event invitees” page screen shot of the App for the group event scheduling and urgency promotion system 100 where an invitee list has been formed.

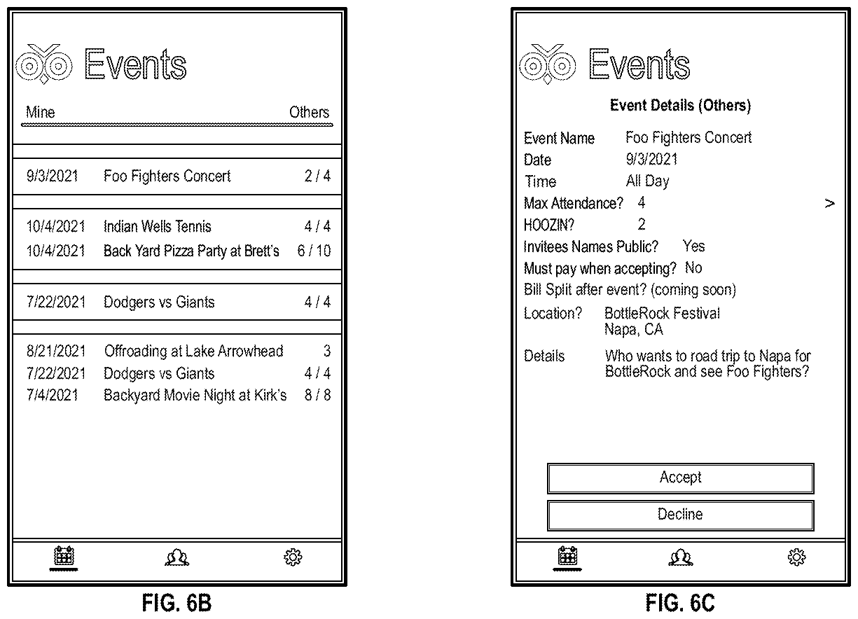

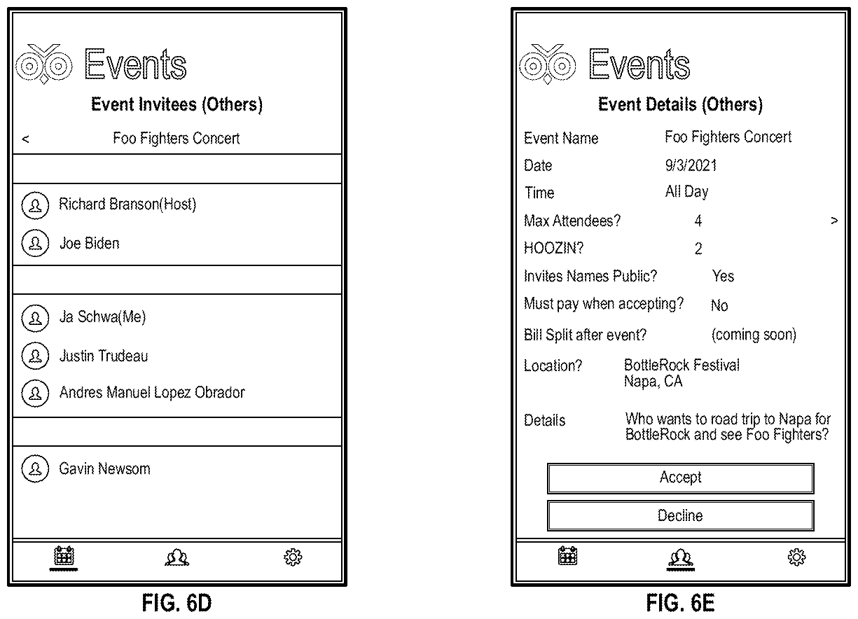

Referring now to FIG. 6A, a “my events list” page screen shot is shown of the App for the group event scheduling and urgency promotion system 100 that displays events (including the new event, Skydiving), events dates, and available tickets remaining for the listed events. FIG. 6B illustrates an “others events list” page screen shot of the App for the group event scheduling and urgency promotion system 100 that displays other people's events, events dates, and available tickets remaining for the listed events. FIG. 6C shows an “others events details” page screen shot of the App for the group event scheduling and urgency promotion system 100 that displays details of other people's events. Some listed event detail options include the ability and optionally the requirement for immediate payment with acceptance. In some embodiments, this immediate payment with acceptance option includes the preconfiguring of payment information. Another listed event detail option includes the ability to split the bill (e.g., payment) after the event. FIG. 6D shows an “others events invitees” page screen shot of the App for the group event scheduling and urgency promotion system 100 where the other accepted attendees are listed. FIG. 6E shows an “others event details accept” page screen shot of the App for the group event scheduling and urgency promotion system 100 where the end user can accept or decline the event.

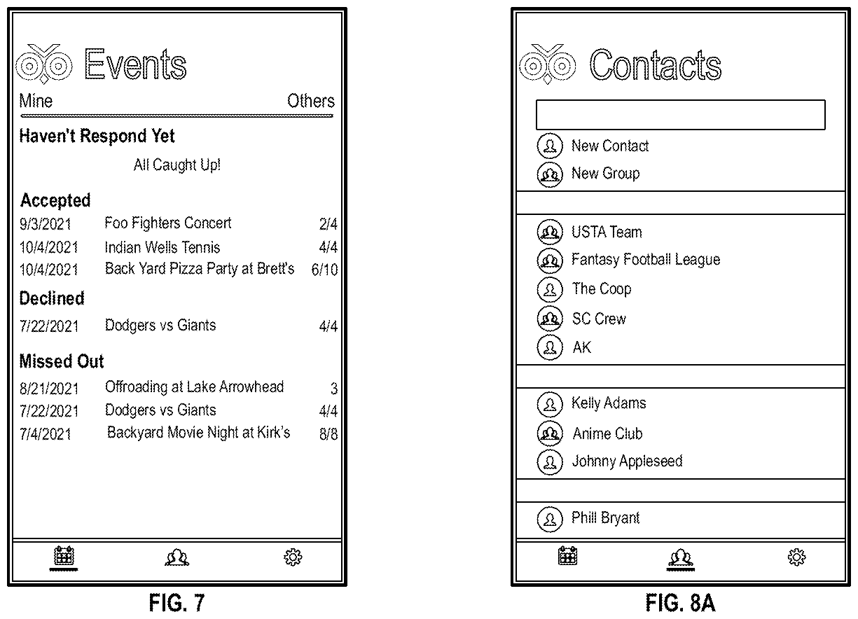

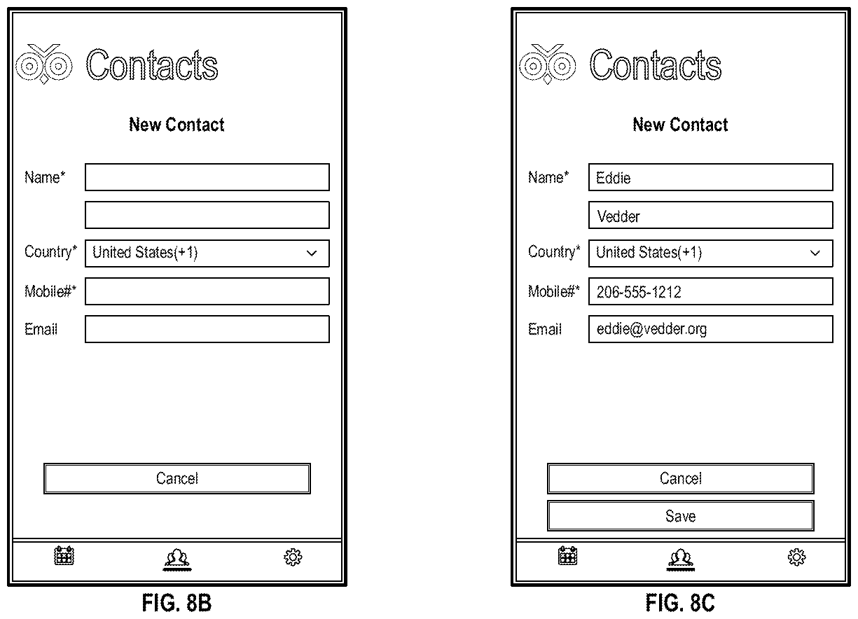

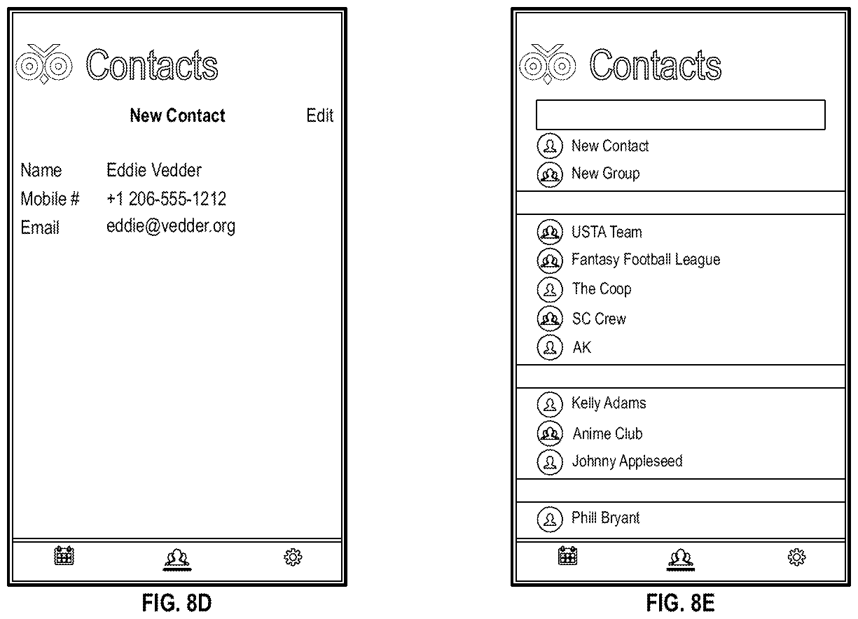

With respect to FIG. 7, an “events status” page screen shot is shown of the App for the group event scheduling and urgency promotion system 100 where the status of accepted events, declined events, and missed events are displayed. FIG. 8A shows a “contacts” page screen shot of the App for the group event scheduling and urgency promotion system 100 where the user's contacts with the App are displayed. FIGS. 8B and 8C show an empty “new contact” page screen shot of the App and a completed “new contact” page screen shot of the App in the group event scheduling and urgency promotion system 100. FIG. 8D shows a “contact details” page screen shot of the App for the group event scheduling and urgency promotion system 100 where a new contact has been added. FIG. 8E shows a “contacts—new group” page screen shot of the App for the group event scheduling and urgency promotion system 100 where a new contact group has been added.

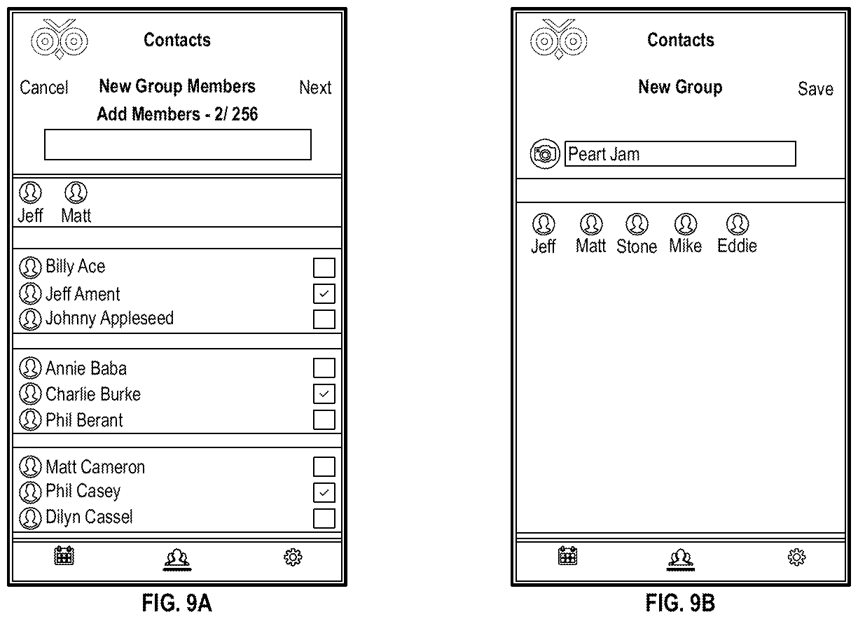

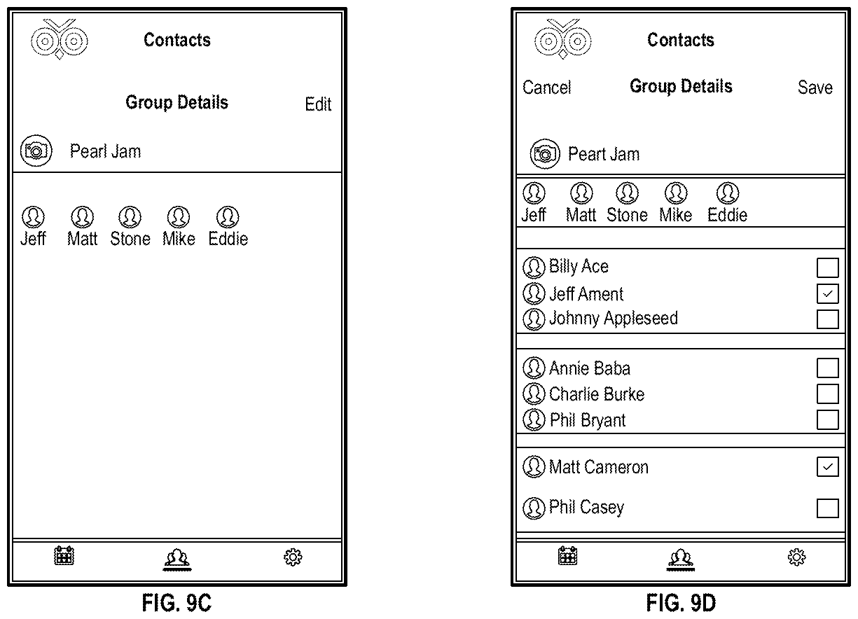

Referring now to FIG. 9A, a “contacts—add members” page screen shot is shown of the App for the group event scheduling and urgency promotion system 100 where a new group members are added to a new contact group. FIG. 9B shows a “contacts—create new group” page screen shot of the App for the group event scheduling and urgency promotion system 100 where the contacts of a new group are created. FIG. 9C shows a “contacts—group details” page screen shot of the App for the group event scheduling and urgency promotion system 100 where group details are displayed. FIG. 9D shows a “contacts—group details edit” page screen shot of the App for the group event scheduling and urgency promotion system 100 where group details may be edited.

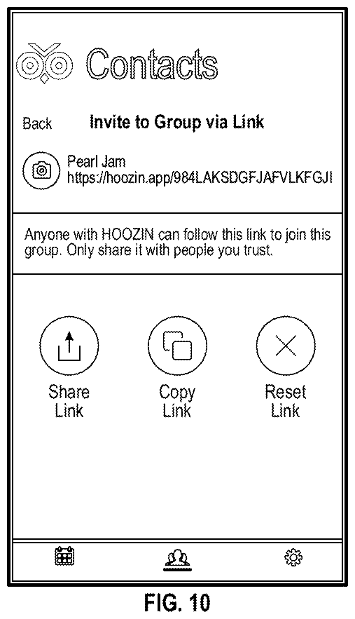

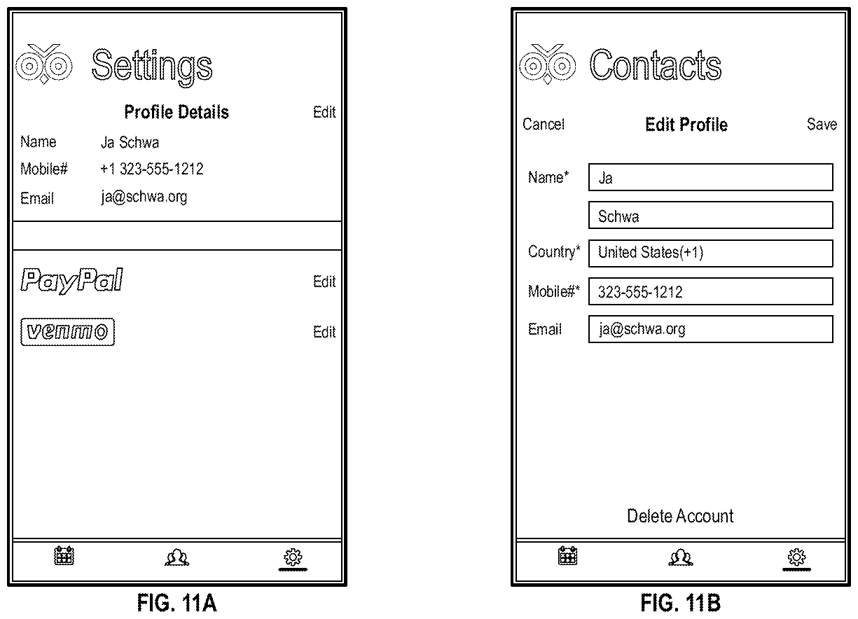

With respect to FIG. 10, a “contacts—invite link” page screen shot is shown of the App for the group event scheduling and urgency promotion system 100 where a group of people are invited to an event via a link. FIG. 11A shows a “settings—profile details” page screen shot of the App for the group event scheduling and urgency promotion system 100 where profile details are shown including user name, mobile number, email address, and payment information (which may be used to facilitate instant purchases of invitations that require immediate payment). FIG. 11B shows a “settings—edit profile” page screen shot of the App for the group event scheduling and urgency promotion system 100 where profile details are editable.

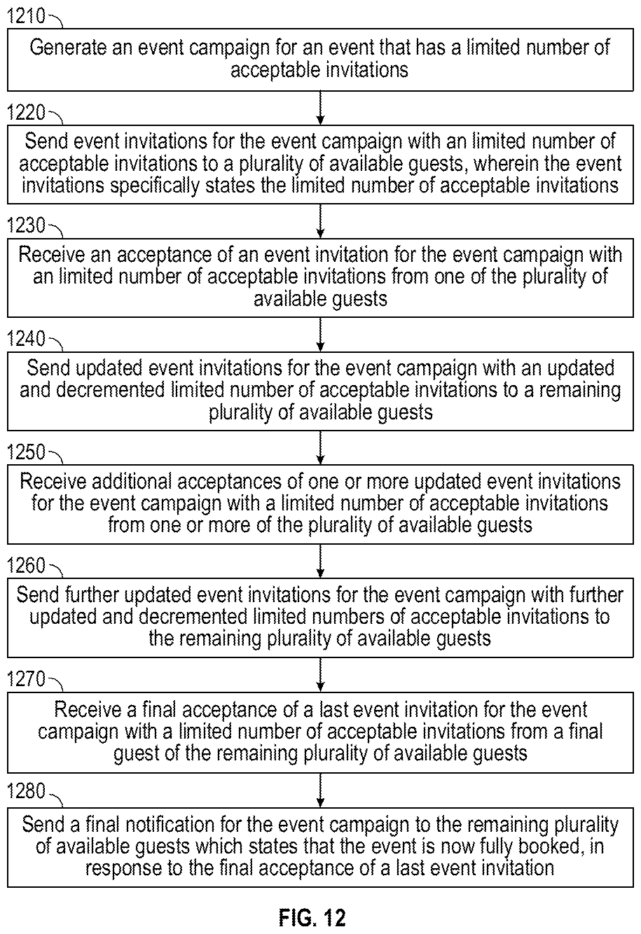

FIG. 12 is a logic diagram showing a method for a group event scheduling and urgency promotion system. As shown in FIG. 12, at operation 1210, an event campaign is generated for an event that has a limited number of acceptable invitations. Additionally, at operation 1220, event invitations are sent for the event campaign with an limited number of acceptable invitations to a plurality of available guests, wherein the event invitations specifically states the limited number of acceptable invitations. At operation 1230, an acceptance is received of an event invitation for the event campaign with an limited number of acceptable invitations from one of the plurality of available guests. At operation 1240, updated event invitations are sent for the event campaign with an updated and decremented limited number of acceptable invitations to a remaining plurality of available guests.

At operation 1250, additional acceptances are received of one or more updated event invitations for the event campaign with a limited number of acceptable invitations from one or more of the plurality of available guests. At operation 1260, further updated event invitations are sent for the event campaign with further updated and decremented limited numbers of acceptable invitations to the remaining plurality of available guests. At operation 1270, a final acceptance is received of a last event invitation for the event campaign with a limited number of acceptable invitations from a final guest of the remaining plurality of available guests. At operation 1280, a final notification is sent for the event campaign to the remaining plurality of available guests which states that the event is now fully booked, in response to the final acceptance of a last event invitation.

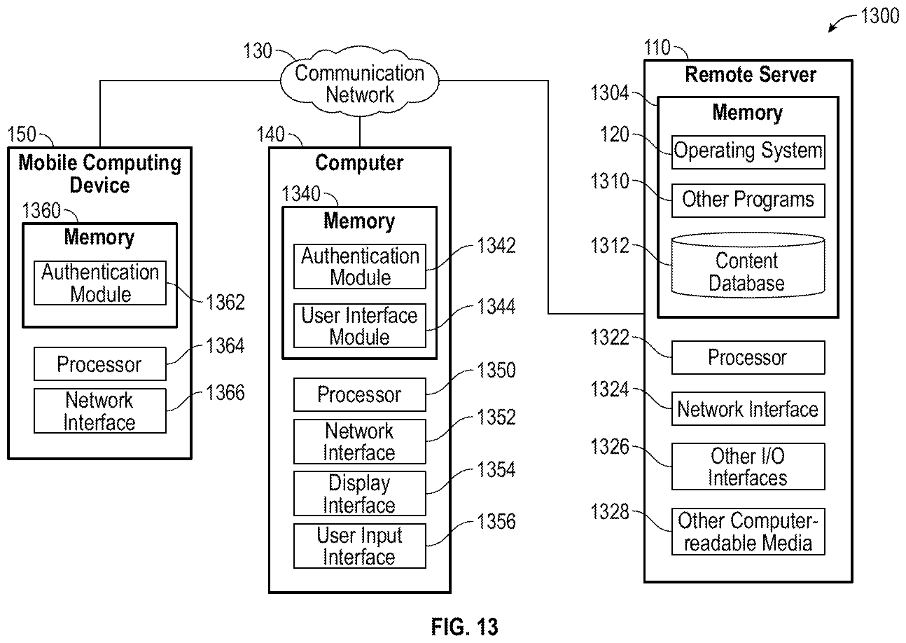

FIG. 13 shows a system diagram that presents one implementation of computing systems for group event scheduling and urgency promoting system. System 1300 includes server 110 and an operating system 120 that are connected, via a communication network 130, to one or more computers 140 and one or more mobile computing devices 150.

As described herein, the server 110 is a computing device that can perform functionality described herein for implementing an operating system 120. One or more special purpose computing systems may be used to implement the server 110. Accordingly, various embodiments described herein may be implemented in software, hardware, firmware, or in some combination thereof. The server 110 includes memory 1304, one or more processors 1322, network interface 1324, other input/output (I/O) interfaces 1326, and other computer-readable media 1328. In some embodiments, the server 110 may be implemented by cloud computing resources.

Processor 1322 includes one or more processing devices that execute computer instructions to perform actions, including at least some embodiments described herein. In various embodiments, the processor 1322 may include one or more central processing units (CPU), programmable logic, or other processing circuitry.

Memory 1304 may include one or more various types of non-volatile and/or volatile storage technologies. Examples of memory 1304 include, but are not limited to, flash memory, hard disk drives, optical drives, solid-state drives, various types of random-access memory (RAM), various types of read-only memory (ROM), other computer-readable storage media (also referred to as processor-readable storage media), or other memory technologies, or any combination thereof. Memory 1304 may be utilized to store information, including computer-readable instructions that are utilized by processor 1322 to perform actions, including at least some embodiments described herein.

Memory 1304 may include a content database 1312 for storing content in accordance with the group event scheduling and urgency promoting system. Memory 1304 may also store other programs 1310. The other programs 1310 may include other operating systems, user applications, or other computer programs that are accessible to the mobile computing device 150.

Network interface 1324 is configured to communicate with other computing devices, via a communication network 106. Network interface 1324 includes transmitters and receivers (not illustrated) to send and receive data.

Other I/O interfaces 1326 may include interfaces for various other input or output devices, such as audio interfaces, other video interfaces, USB interfaces, physical buttons, keyboards, haptic interfaces, tactile interfaces, or the like. Other computer-readable media 1328 may include other types of stationary or removable computer-readable media, such as removable flash drives, external hard drives, or the like.

The computers 140 include memory 1340, one or more processors 1350, network interface 1352, display interface 1354, and user input interface 1356. The memory 1340, processor 1350, and network interface 1352 may be similar to, include similar components, or incorporate embodiments of memory 1304, processor 1322, and network interface 1324 of server 110, respectively. Thus, processor 1350 includes one or more processing devices that execute computer instructions to perform actions, including at least some embodiments described herein. In various embodiments, the processor 1350 may include one or more CPUs, programmable logic, or other processing circuitry. The network interfaces 1352 is also configured to communicate with the mobile computing devices, such as via Bluetooth or other short-range communication protocol or technology.

Memory 1340 may include one or more various types of non-volatile and/or volatile storage technologies. Memory 1340 may be utilized to store information, including computer-readable instructions that are utilized by processor 1350 to perform actions, including at least some embodiments described herein. Memory 1340 may store various modules or programs, including authentication module 1342 and user interface module 1344. The authentication module 1342 may perform actions that coordinate the authentication between the mobile computing devices and the server 110. The user interface module 1344 receives graphical user interface data from the server 110 for display or presentation, via the display interface 1354, to the user of the mobile computing devices. The user interface module 1344 also receives user input via the user input interface 1356 and provides that input back to the server 110. In various embodiments, one or more capacitive, radar, infrared, LIDAR, or other type of gesture capturing sensors may be used to receive the user input. In some other embodiments, the user interface module 1344 may receive user inputs via other input mechanisms, such as a mouse, stylus, voice-recognition, or other input sensors. Memory 1340 may also store other programs.

The mobile computing devices 150 include memory 1360, one or more processors 1364, and a network interface 1366. The memory 1360, processor 1364, and network interface 1366 may be similar to, include similar components, or incorporate embodiments of memory 1340, processor 1350, and network interfaces 1352 of the mobile computing devices 150. Thus, processor 1364 includes one or more processing devices that execute computer instructions to perform actions, including at least some embodiments described herein. In various embodiments, the processor 1364 may include one or more CPUs, programmable logic, or other processing circuitry. The network interface 1366 is configured to communicate with the mobile computing device 150.

Memory 1360 may include one or more various types of non-volatile and/or volatile storage technologies. Memory 1360 may be utilized to store information, including computer-readable instructions that are utilized by processor 1364 to perform actions, including at least some embodiments described herein. Memory 1360 may store various modules or programs, including authentication module 1362.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A system for group event scheduling and urgency promoting system, the system comprising:
the remote server includes a server memory that stores server computer instructions and a server processor that when executing the server computer instructions causes the remote server to:
generate an event campaign for an event that has a limited number of acceptable invitations;
send event invitations for the event campaign with an limited number of acceptable invitations to a plurality of available guests, wherein the event invitations specifically states the limited number of acceptable invitations;
receive an acceptance of an event invitation for the event campaign with an limited number of acceptable invitations from one of the plurality of available guests;
send updated event invitations for the event campaign with an updated and decremented limited number of acceptable invitations to a remaining plurality of available guests, in response to the acceptance of an event invitation for the event campaign with an limited number of acceptable invitations;
receive additional acceptances of one or more updated event invitations for the event campaign with a limited number of acceptable invitations from one or more of the plurality of available guests;
send further updated event invitations for the event campaign with further updated and decremented limited numbers of acceptable invitations to the remaining plurality of available guests, in response to the additional acceptances of one or more event invitations for the event campaign with an limited number of acceptable invitations;
receive a final acceptance of a last event invitation for the event campaign with a limited number of acceptable invitations from a final guest of the remaining plurality of available guests; and
send a final notification for the event campaign to the remaining plurality of available guests which states that the event is now fully booked, in response to the final acceptance of a last event invitation for the event campaign with a limited number of acceptable invitations.

2. The system of claim 1, further comprising a plurality of mobile computing devices, each personal mobile computing device including a device memory that stores device computer application instructions and a device processor that when executing the device computer application instructions causes the personal mobile computing device to:
receive, at a mobile computing device of the plurality of mobile computing devices, event invitations for the event campaign with a limited number of acceptable invitations, wherein the event invitations specifically states the limited number of acceptable invitations;
send, at the mobile computing device of the plurality of mobile computing devices, an acceptance of an event invitation for the event campaign with an limited number of acceptable invitations;
receive, at another mobile computing device of the plurality of mobile computing devices, an updated event invitation for the event campaign with an updated and decremented limited number of acceptable invitations;
send, at the another mobile computing device of the plurality of mobile computing devices, an additional acceptance of an event invitation for the event campaign with a limited number of acceptable invitations; and
receive, at still another mobile computing device of the plurality of mobile computing devices, a final notification for the event campaign to the remaining plurality of available guests which states that the event is now fully booked.

3. The system of claim 1, wherein the event invitation for the event campaign with an limited number of acceptable invitations includes purchase information regarding the acceptable invitations, wherein the purchase information includes a price.

4. The system of claim 3, wherein the event invitation for the event campaign with an limited number of acceptable invitations includes a purchase link to the acceptable invitations for immediate purchasing of an acceptable invitation.

5. The system of claim 1, wherein the updated event invitation for the event campaign with an updated and decremented limited number of acceptable invitations includes updated purchase information regarding the acceptable invitations after one or more purchases of acceptable invitations have occurred, wherein the updated purchase information includes a price change.

6. The system of claim 5, wherein the updated event invitation for the event campaign with an updated and decremented limited number of acceptable invitations includes purchase link to the updated and decremented limited number of acceptable invitations.

7. The system of claim 5, wherein the price change is a price increase or a price decrease.

8. The system of claim 1, wherein the event invitations, updated event invitations, and final notifications are included in one or more of text messages, emails, instant messages, social media messages, or notifications.

9. A method for group event scheduling and urgency promotion, the method comprising:
generating an event campaign for an event that has a limited number of acceptable invitations;
sending event invitations for the event campaign with an limited number of acceptable invitations to a plurality of available guests, wherein the event invitations specifically states the limited number of acceptable invitations;
receiving an acceptance of an event invitation for the event campaign with an limited number of acceptable invitations from one of the plurality of available guests;
sending updated event invitations for the event campaign with an updated and decremented limited number of acceptable invitations to a remaining plurality of available guests;
receiving additional acceptances of one or more updated event invitations for the event campaign with a limited number of acceptable invitations from one or more of the plurality of available guests;
sending updated event invitations for the event campaign with updated and decremented limited numbers of acceptable invitations to the remaining plurality of available guests;
receiving a final acceptance of a last event invitation for the event campaign with a limited number of acceptable invitations from a final guest of the remaining plurality of available guests; and
sending a final notification for the event campaign to the remaining plurality of available guests which states that the event is now fully booked.

10. The method of claim 9, further comprising:
receiving, at a mobile computing device of the plurality of mobile computing devices, event invitations for the event campaign with a limited number of acceptable invitations, wherein the event invitations specifically states the limited number of acceptable invitations;
sending, at the mobile computing device of the plurality of mobile computing devices, an acceptance of an event invitation for the event campaign with an limited number of acceptable invitations;
receiving, at another mobile computing device of the plurality of mobile computing devices, an updated event invitation for the event campaign with an updated and decremented limited number of acceptable invitations;
sending, from the another mobile computing device of the plurality of mobile computing devices, an additional acceptance of an event invitation for the event campaign with a limited number of acceptable invitations; and
receiving, from still another mobile computing device of the plurality of mobile computing devices, a final notification for the event campaign to the remaining plurality of available guests which states that the event is now fully booked.

11. The method of claim 9, wherein the event invitation for the event campaign with an limited number of acceptable invitations includes purchase information regarding the acceptable invitations, wherein the purchase information includes a price.

12. The method of claim 11, wherein the event invitation for the event campaign with an limited number of acceptable invitations includes a purchase link to the acceptable invitations for immediate purchasing of an acceptable invitation.

13. The method of claim 9, wherein the updated event invitation for the event campaign with an updated and decremented limited number of acceptable invitations includes updated purchase information regarding the acceptable invitations after one or more purchases of acceptable invitations have occurred, wherein the updated purchase information includes a price change.

14. The method of claim 13, wherein the updated event invitation for the event campaign with an updated and decremented limited number of acceptable invitations includes purchase link to the updated and decremented limited number of acceptable invitations.

15. The method of claim 14, wherein the price change is a price increase or a price decrease.

16. The method of claim 9, wherein the event invitations, updated event invitations, and final notifications are included in one or more of text messages, emails, instant messages, social media messages, or notifications.

17. A system for group event scheduling and urgency promoting system, the system comprising:
the server includes a server memory that stores server computer instructions and a server processor that when executing the server computer instructions causes the remote server to:
generate an event campaign for an event that has a limited number of acceptable invitations;
send event invitations for the event campaign with an limited number of acceptable invitations to a plurality of available guests, wherein the event invitations specifically states the limited number of acceptable invitations;
receive an acceptance of an event invitation for the event campaign with an limited number of acceptable invitations from one of the plurality of available guests; and
send updated event invitations for the event campaign with an updated and decremented limited number of acceptable invitations to a remaining plurality of available guests, in response to the acceptance of an event invitation for the event campaign with an limited number of acceptable invitations.

18. The system of claim 17, wherein the system enables an alert to be sent to an alert-requesting available guest when a selected number of acceptable invitations are remaining that notifies the available guest of the selected number of acceptable invitations that are remaining.

19. The system of claim 17, wherein the system enables an automatic purchase to be executed for a requesting available guest when a selected number of acceptable invitations are remaining.

20. The system of claim 17, wherein the event invitation for the event campaign with an limited number of acceptable invitations includes a purchase link to the acceptable invitations for immediate purchasing of an acceptable invitation.
